(19) United States
(12) Patent Application Publication
(10) Pub. No.: US 2024/0400955 A1
(43) Pub. Date: Dec. 5, 2024

(54) System and Process for Reducing The Time Required to Age A Raw Distillate by Expedited Aging

(71) Applicant: Sound Crafted Spirits LLC, Katy, TX (US)

(72) Inventors: Lyle V. Lehman, Katy, TX (US); Don Ritter, Addison, TX (US); Stretch Head, Long Beach, CA (US)

(73) Assignee: Sound Crafted Spirits LLC, Katy, TX (US)

(21) Appl. No.: 18/798,426

(22) Filed: Aug. 8, 2024

Related U.S. Application Data
(62) Division of application No. 16/359,877, filed on Mar. 20, 2019.
(60) Provisional application No. 62/781,580, filed on Dec. 18, 2018.
(60) Provisional application No. 62/647,763, filed on Mar. 25, 2018.

(51) Int. Cl. C12H 1/22; C12G 3/04; C12G 3/07; C12H 1/16

(52) U.S. Cl. CPC C12H 1/22; C12G 3/04; C12H 1/16; C12G 3/07

(57) ABSTRACT

Systems for expedited aging include exposing wood pieces to an alcohol-containing fluid with any one or more of pressure, vacuum and music. Swelling characteristics of the wood pieces may be measured. One or more fluid properties may be measured during the process to determine endpoints. Some process endpoints may be based upon any one or more of taste and aroma attributes, via a flavor profile or aroma profile, respectively. Diminishing change in the fluid property over time may indicate an endpoint to the process; or by comparison to the properties of an external reference.

### REFERENCE TO RELATED APPLICATIONS

This application claims the benefit of prior U.S. provisional patent application Ser. No. 62/647,763 filed Mar. 25, 2018 entitled, “System and Process for Reducing The Time Required to Age a Raw Distillate By Expedited Aging”, herein incorporated by reference in its entirety; prior U.S. provisional patent application Ser. No. 62/781,580 filed Dec. 18, 2018 entitled, “System and Process for Reducing The Time to Age a Raw Distillate By Expedited Aging (Second Provisional Application)” herein incorporated by reference in its entirety; and is a divisional application based upon utility patent application Ser. No. 16/359,877 filed Mar. 20, 2019 entitled, “System and Process for Reducing The Time Required to Age a Raw Distillate By Expedited Aging”, herein incorporated by reference in its entirety, and continuation utility patent application Ser. No. 17/989,434 filed Nov. 17, 2022 entitled “Process For Reducing The Time Required to Age a Raw Distillate by Expedited Aging” herein incorporated by reference in its entirety.

### STATEMENT REGARDING FEDERALLY SPONSORED RESEARCH

Not applicable.

### FIELD OF INVENTION

The embodiments described herein relate to reducing the time required to age a raw, from the still, distilled spirit mixture, into a desirable product. The embodiments described herein additionally relate to further enhancing the desirability of the product by additionally exposing the desirable product to music.

Embodiments of the desirable product obtained from expedited aging have taste and aroma characteristics comparable to a relatively higher price point commercially available aged distilled spirits, for example Pappy Van Winkle brand. Such desirable product characteristics further include comparable water, alcohol, sugar and color to relatively higher price point commercially available distilled spirits; achieved in less time than has historically been used to produce relatively higher price point commercially available aged distilled spirits.

### BACKGROUND

Relatively higher price point commercially available distilled spirits have been historically desirable, in large part, because of taste, color and aroma characteristics. These characteristics have traditionally been developed relatively slowly over time. Time can include years, a decade, and multiples of decades. These relatively slow methods generally include contacting a raw distillate (generally considered lacking desirable taste and aroma characteristics) with wood known to impart desirable characteristic to a raw distillate. The undesirably slow method also includes a sufficient passage of time (years, a decade and multiples of decades by example) and under carefully controlled environmental conditions, including temperature, pressure and humidity.

The combination of time, physical storage space and controlled environmental conditions required to produce relatively higher price point commercially available distilled spirits on a commercial scale is costly. Such scale and cost limit the commercial availability of the types of distillates considered historically desirable. There is yet a need to reduce the time, scale and cost of aging a raw distillate into a product comparable to relatively higher price point commercially available distilled spirit.

### BRIEF SUMMARY

Disclosed herein are embodiments of systems and processes for reducing the time for aging distillates (expedited aging) to produce a desirable product comparable to a relatively higher price point commercially-available aged spirits. The desirable product may be additionally be exposed to music further enhancing desirability. One embodiment of a system is comprised of (1) a feed section, (2) one or more treatment sections, (3) a circulating section, and (3) one or more aging sections. One or more treatment sections are comprised of treatment cartridges, usually filled with wood pieces. In some embodiments, one or more treatment cartridges may be changed during operation of systems and processes without stopping an entire process. In some embodiments, one or more treatment cartridges or pressure vessels may be subjected to various patterns of pressure and vacuum application, with or without fluid present. Other embodiments include a circulating tank for fluid. Still other embodiments include a music treatment system and process.

An embodiment of an expediting aging process is comprised of the steps of (1) feeding, (2) circulating through at least one treatment section comprised of one or more repeating units, (3) monitoring, and (4) aging. The circulating step may employ any one of three circulating embodiments. Another embodiment adds the step of applying and holding a vacuum or pressure on one or more treatment cartridges in the system. Another embodiment may further include repeating the steps of circulating and applying and holding the vacuum or pressure multiple times. In some embodiments, holding the vacuum or pressure in a treatment cartridge may be when the treatment cartridge contains fluid. In other embodiments, there may be little or no fluid present in the treatment cartridge. In some embodiments, treatment cartridges may be changed without stopping the entire process. Another embodiment adds the step of exposing the product of one of the embodiments of the process to music and wood.

### BRIEF DESCRIPTION OF THE DRAWINGS

For the purpose of illustrating various embodiments, the drawings depict one or more embodiments that are exemplary; it being understood, however, that this disclosure is not intended to be limited to the precise arrangements and instrumentalities shown.

This patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

FIG. 1 is a side view of an embodiment of a system for expedited aging.

FIG. 2 is a side view of an embodiment of a feed section of a system.

FIG. 3 is a side view of an embodiment of a repeating unit in a treatment section.

FIG. 4 is a side view of an embodiment of a circulating section.

FIG. 5 is a side view of an embodiment of a circulating section including an optional circulating tank.

FIG. 6 is a side view of an embodiment of a system with a feed section, a treatment section depicting one repeating unit and a circulating section.

FIG. 7 is a side view of an embodiment of one repeating unit of an aging section.

FIG. 8 is a side view of an embodiment of three repeating units of an aging section.

FIG. 9 is a side view of an embodiment of a treatment section having two repeating units.

FIG. 10 depicts an embodiment of a process for reducing the aging time of a distillate.

FIG. 11 depicts another embodiment of a process for reducing the aging time of a distillate by employing a vacuum or pressure step; and repeating the steps of circulating and applying and holding the vacuum or pressure.

FIG. 12 depicts another embodiment of a process for reducing the aging time of a distillate, including music treatment.

FIG. 13 depicts another embodiment of a circulating section with vessel repeating units.

FIG. 14 depicts another embodiment of a circulating section with Z=0 vessel repeating units.

FIG. 15 depicts the modes for circulating, for example using the embodiment in FIG. 14.

FIG. 16. Depicts another embodiment of a circulating section with Z=0 vessel repeating units

FIG. 17 Depicts the modes for circulating, for example using the embodiment in FIG. 16.

FIG. 18 depicts an embodiment of a music treatment system.

FIG. 19 depicts light transmission results over time of a fluid treated in a process and system embodiment.

FIG. 20 depicts light transmission results over time of a fluid treated in another process and system embodiment.

### DETAILED DESCRIPTION

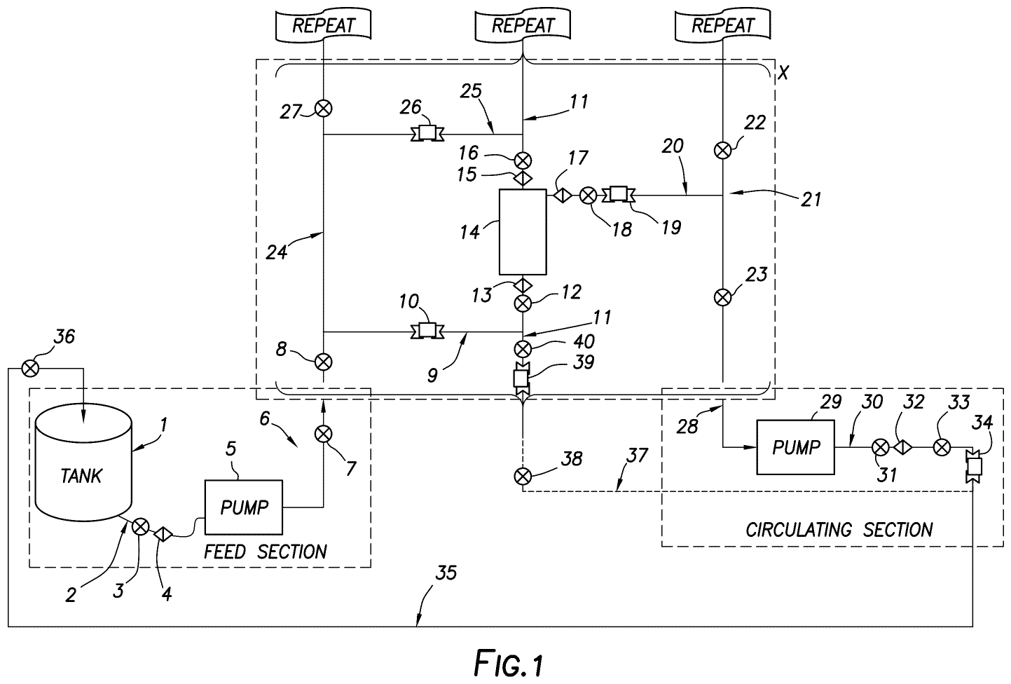

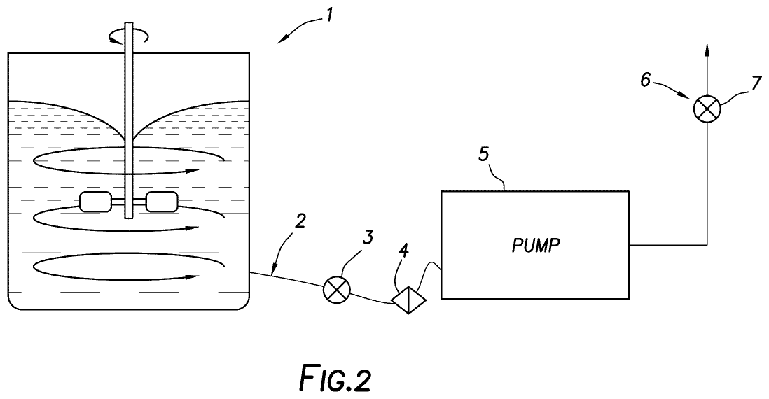

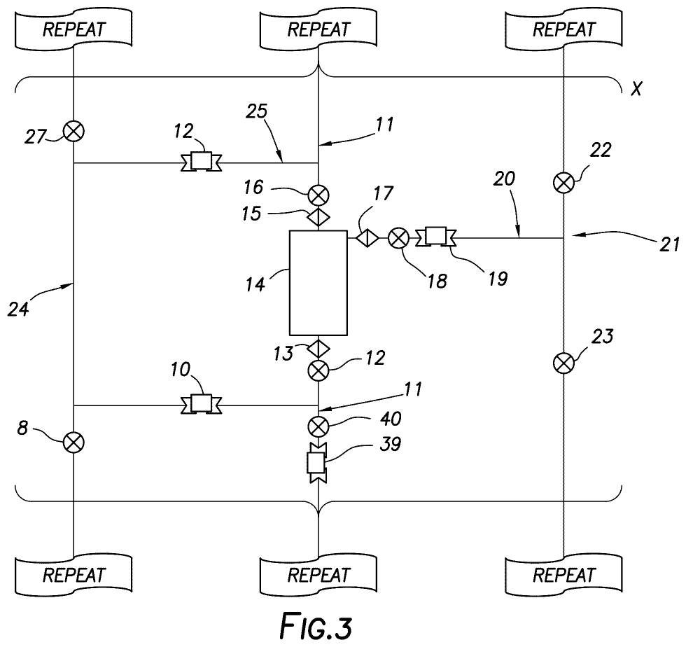

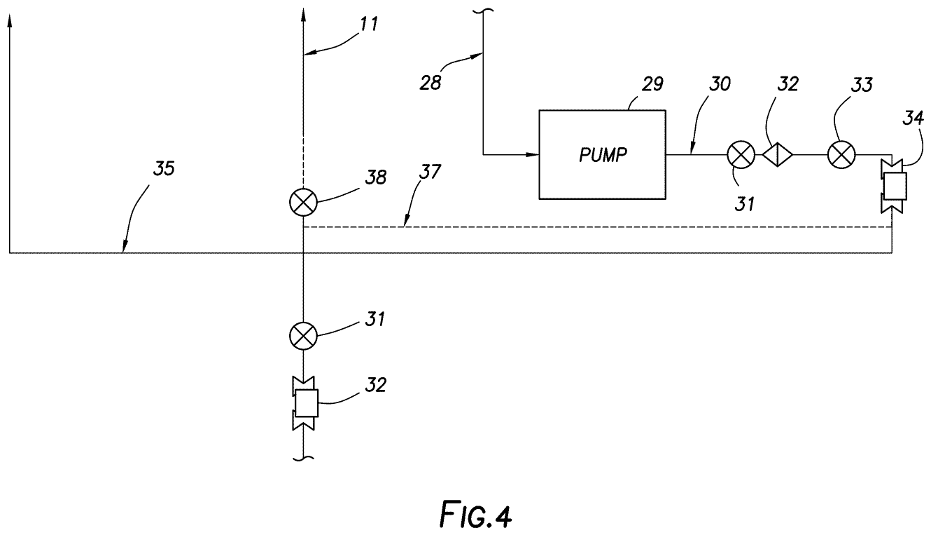

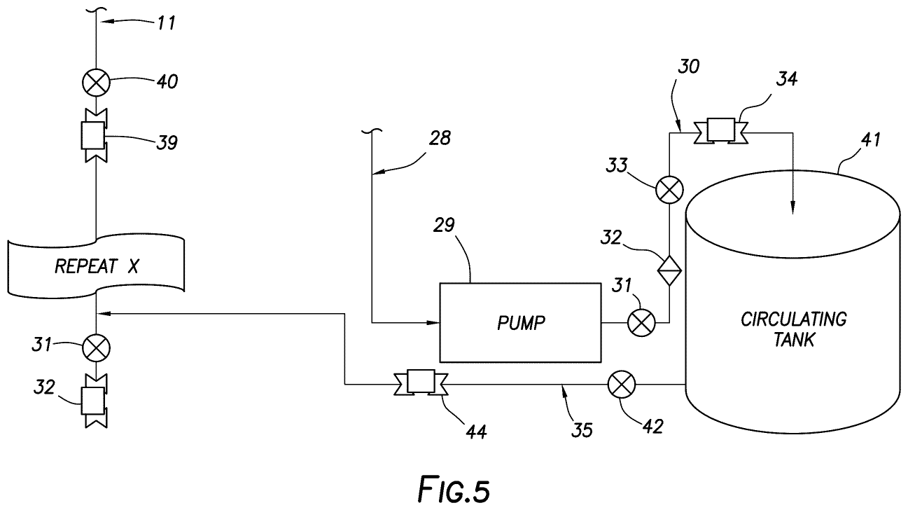

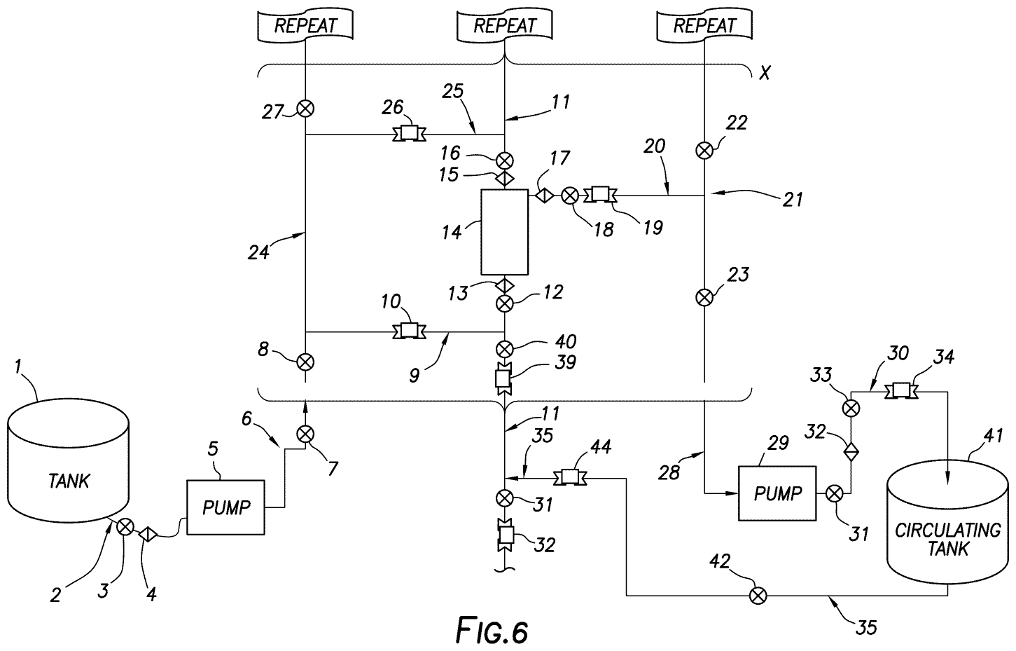

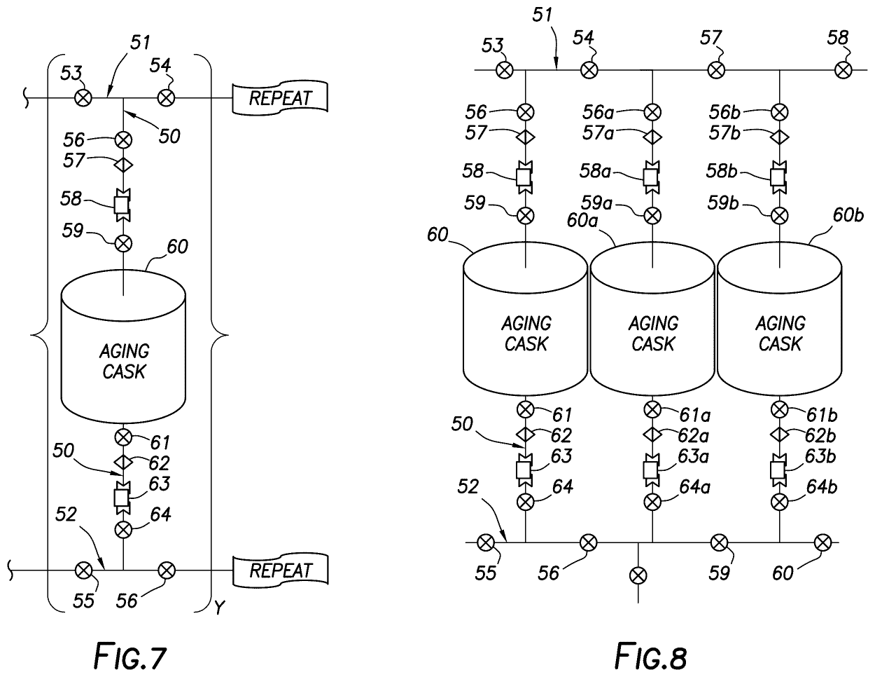

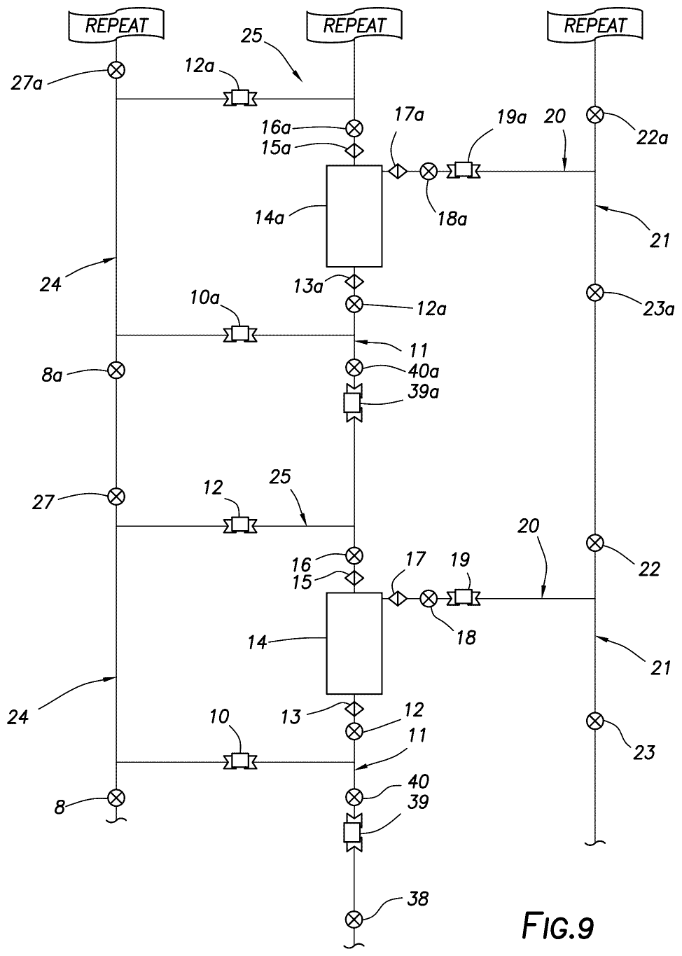

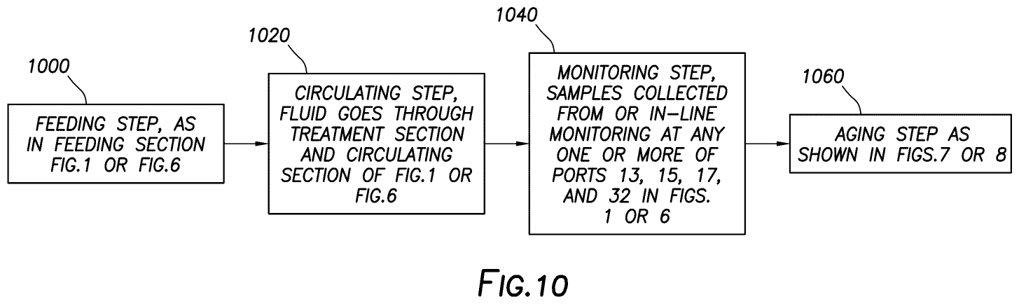

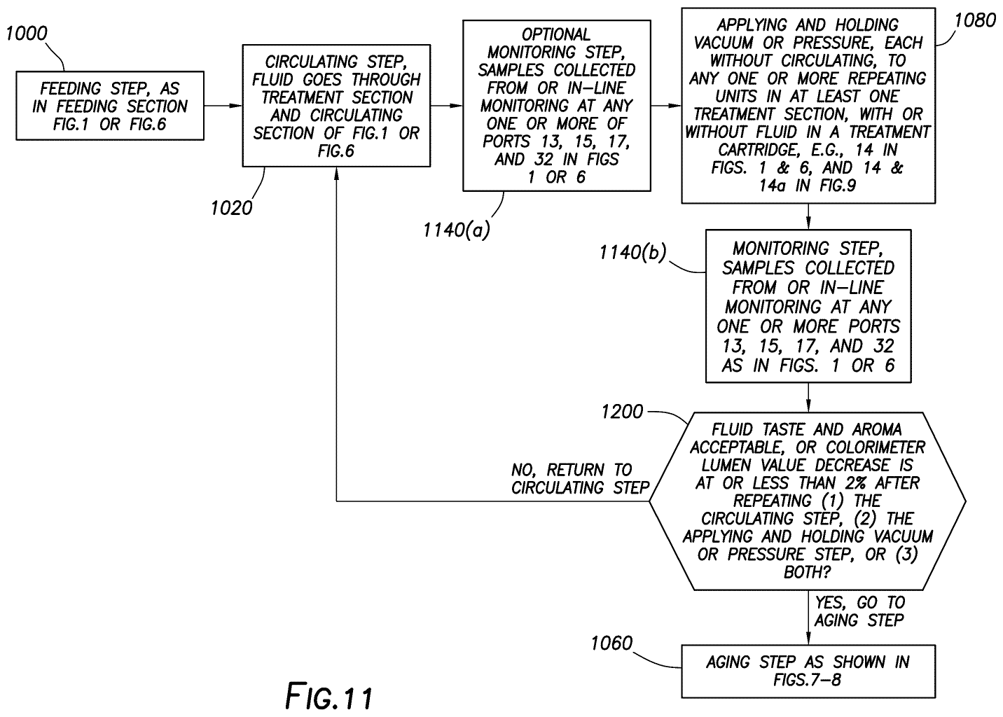

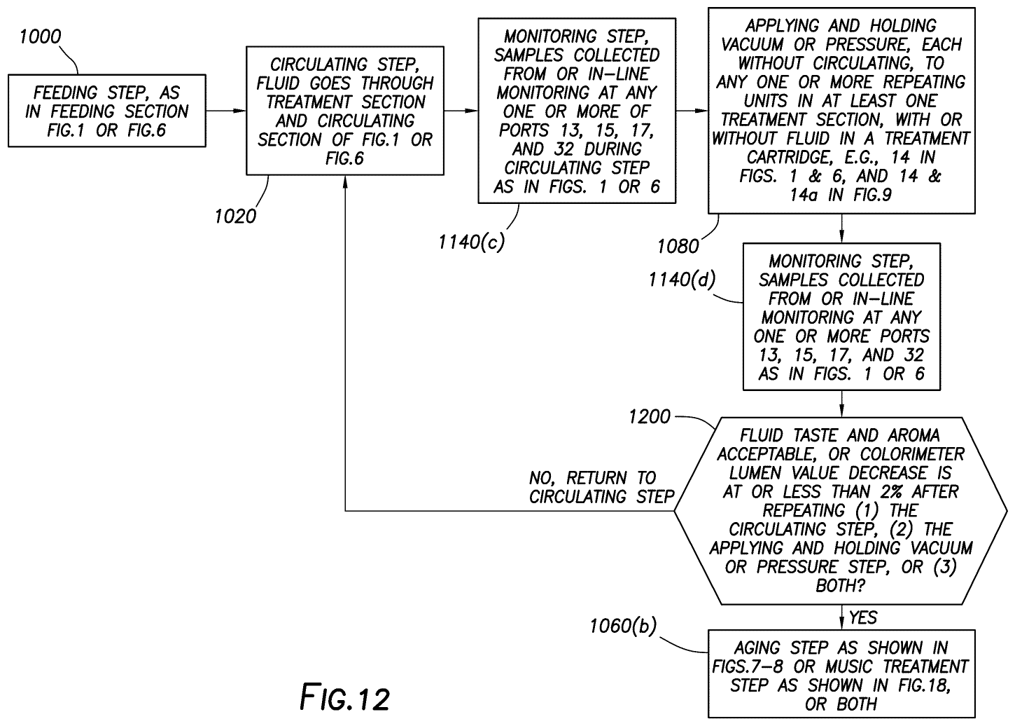

The embodiment of a system for expedited spirits aging depicted in FIG. 1 is generally comprised of (1) a feed section, (2) one or more repeating units in a treatment section, and (3) a circulating section. The feed section is comprised of tank 1, line 2, valve 3, port 4, pump 5, line 6 and valve 7. FIG. 2 additionally depicts an embodiment of the feed section and further illustrates an impeller for stirring the fluids in tank 1. FIG. 3 additionally depicts one repeating unit in a treatment section, which may optionally be repeated in a system up to thirty times. The repeating units are intended to be easily changed out for new ones while the system is in operation. FIG. 4 depicts embodiments of a circulating section.

FIG. 1 depicts an embodiment with one repeating unit in a treatment section (X=1, see also FIG. 3) comprised of a first manifold line 24 equipped with valves 8 and 27; a second manifold line 21 equipped with valves 22 and 23. The first manifold line 24 is in removable communication with treatment cartridge 14 through lines 25, 9 and 11. Line 25 removably connects to treatment cartridge 14 through line 11 and valve 16. Port 15 provides optional sampling access or may be equipped with one or more sensor arrays.

The first manifold line 24 is additionally in removable communication with treatment cartridge 14 through lines 9 and 11. Line 9 removably connects to treatment cartridge 14 through line 11 and valve 12. Port 13 provides optional sampling access or may be equipped with one or more sensor arrays.

The second manifold line 21 is additionally in removable communication with treatment cartridge 14 through line 20 and connector 19. Line 20 is further equipped with valve 18 and port 17. Port 17 provides for optional sampling access or may be equipped with one or more sensor arrays.

Valve 40 and connector 39 are the last elements of a treatment section having one repeating unit (X=1). The treatment section may be isolated from the first manifold line 24 by closing valves 16 and 12. The treatment section may be isolated from the second manifold line by closing valve 18. Treatment cartridge 14 may be removed from the treatment section by releasing connectors 26, 10 and 19. Additional repeating units of a treatment section (X>1) may be added to the system as shown by repeating the treatment section as depicted in FIG. 1. See, for example, FIG. 9. Although FIGS. 1 and 9 depict embodiments with repeating units added in the vertical direction, additional repeating units may be added in any direction.

Referring to FIG. 1, the circulating section is comprised of line 28 connected to pump 29, line 30, valve 31, port 32, valve 33 and connector 34. Fluid exits the second manifold line 21 which is in removable communication with line 28. The fluid enters the circulating section through line 28. Line 28 is in removable communication with pump 29, line 30, valve 31, port 32, valve 33 and connector 34. In the embodiment depicted by the solid line 35 in FIG. 1, the fluid is circulated back into tank 1 through line 35 and valve 36. In another embodiment depicted by the dotted lines in FIG. 1, the fluid is circulated back into line 11 through dotted line 37, valve 38, connector 39, and valve 40. When valve 12 is closed, the fluid flows into line 9, through connector 10 and back into the first manifold line 24.

FIG. 4 depicts an embodiment of a circulating section. The embodiment in FIG. 4 depicts line 28 in removable communication with tank 1. Tank 1 is not shown in FIG. 4; however, the removable communication with tank 1 is shown in FIG. 1. Pump 29 pumps fluid out of manifold line 28 through line 30, valve 31, port 32, valve 33 and connector 34. As in FIG. 1, line 35 may lead back to tank 1 (not shown in FIG. 4, but shown in FIG. 1). In another embodiment, connector 34 may be in removable communication with line 11 leading back to one or more treatment sections through dashed line 37 and valve 38. FIG. 5 depicts another embodiment of a circulating section. The embodiment depicted in FIG. 5 is shown integrated into the system as shown in FIG. 6. Still referring to FIG. 5, line 28 is in removable communication with the second manifold line 21 to receive fluid. Line 28 is in removable communication with pump 29, line 30, valve 31, port 32, valve 33 and connector 34. Connector 34 provides removable communication to circulating tank 41. Treatment materials (not shown in FIG. 5) may optionally be added to circulating tank 41. Exemplary treatment materials include baked wood, freeze-dried wood, charred wood, oven-roasted wood, flame-roasted wood, burned wood, dehydrated wood, dried wood, raw wood (see, for example, published international application number PCT/US/2009/059984, filing date Oct. 8, 2009 by Daniel Martin Watson, et al., herein incorporated by reference in its entirety), pulverized wood, boiled wood, supercritical fluid extracted wood, burned wood, hydrolyzed wood, enzyme-treated wood, lignin enzyme treated wood, genetically modified wood, selectively bred wood, and combinations thereof.

Still referring to FIG. 5, line 35 leads out of tank 41 to line 11 through valve 42 and connector 44. Optionally, line 35 may instead communicate fluid back to any of line 11 (FIG. 6), tank 1 (FIG. 1), line 2 or line 6 (also FIG. 1). Optionally, tank 41 may be agitated. In some embodiments, tank 41 may be agitated using the same type of impeller system shown in FIG. 2 on tank 1.

In some embodiments, additional flavor development can be achieved by filling tank 41 with flavoring pieces. In some embodiments, the flavoring pieces are plain or flavored French charred oak wood pieces. In some embodiments, the flavored French charred oak pieces are flavored with any one or more of vanilla, coffee, port, and cola flavored soda. In some embodiments, the cola flavored soda is Coca Cola® brand cola flavored soda. A flavored French charred oak piece may be prepared by soaking the wood piece in the desired flavoring agent for at least a week, or until the wood becomes saturated with the flavoring and no additional absorption of the flavoring the flavoring agent occurs. This can be determined by increases in the weight a wood piece over time. Occasionally, the flavoring process may be carried out under positive pressure.

Referring now to FIG. 13, that figure depicts yet another embodiment of a feeding section and circulating section. The feeding section is comprised of pump 72. Pump 72 may, for example, be an air compressor type pump. Line 71 depicts the air line for an air compressor type pump. In some embodiments, the pump is a spinning vane pump. Pump 72 has an inlet side 73 (lower pressure) and an outlet side (higher pressure) 74. Pump 72 is in removable communication with vessel 76 through valve 75 and port 78. The treatment section of FIG. 13 employs a first vessel 76 and a second vessel 77.

The embodiment in FIG. 13 has at least one additional vessel (“77(Z+1)”, Z=1 or greater). Not all of the vessels of FIG. 13 can be isolated and replaced on the fly during system operation as can the embodiments in FIGS. 1-5. However, any of the number, Z, of repeating units like vessel 77 (Z=1 or greater), can be isolated. For example, closing valves 90 and 96 isolates the additional vessels 77 (Z+1) as may be needed during operation. After isolation, the contents of the vessel, for example the wood pieces or fluid, can be sampled, removed and replaced. Thereafter, the vessel can be returned to operation by reconnecting to the system. The final repeating unit is reflected in FIG. 13 as “Z+1.”

Still referring to FIG. 13, vessel 77 is equipped with a removable top equipped with a first sealed opening 84 and a second sealed opening 86. Sealed opening 84 is in removable communication with line 81, pressure gauge 82 and valve 83. Line 81 is in removable communication with vessel 76.

Still referring to vessel 77, sealed opening 86 is fitted with a dip tube 85 that extends to within about 95 percent of the height of vessel 77. Dip tube 85 is in removable communication with valve 87 and also line 89 and valve 90.

As previously mentioned, additional repeating units (Z=1 or greater) may be added to accommodate additional desired throughput. The terminal unit is unit Z+1 in FIG. 13. In one embodiment, Z=1 and the circulating section is comprised of three vessels. The first vessel is vessel 76, the second is vessel 77 and the terminal vessel is 77(Z=1, therefore “77(2)”). The terminal vessel is in removable communication with vacuum pump 91 through sealed port 88 and valve 90(Z+1). Vacuum pump 91 is equipped with valve 92.

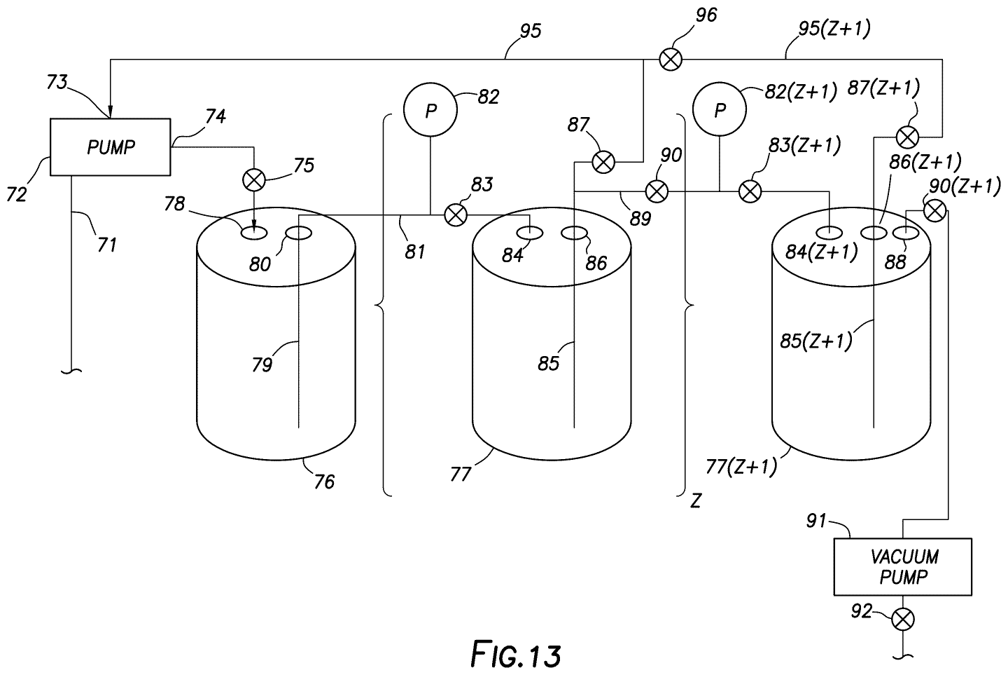

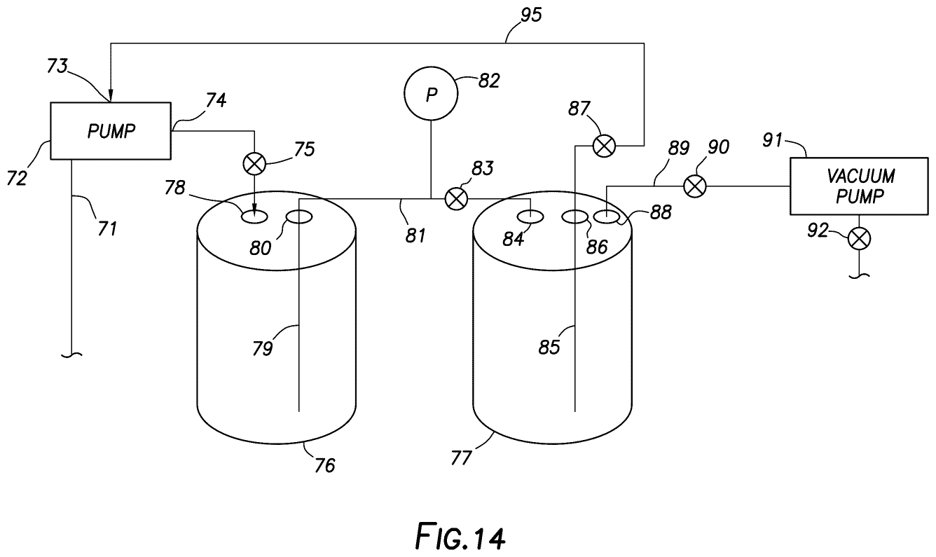

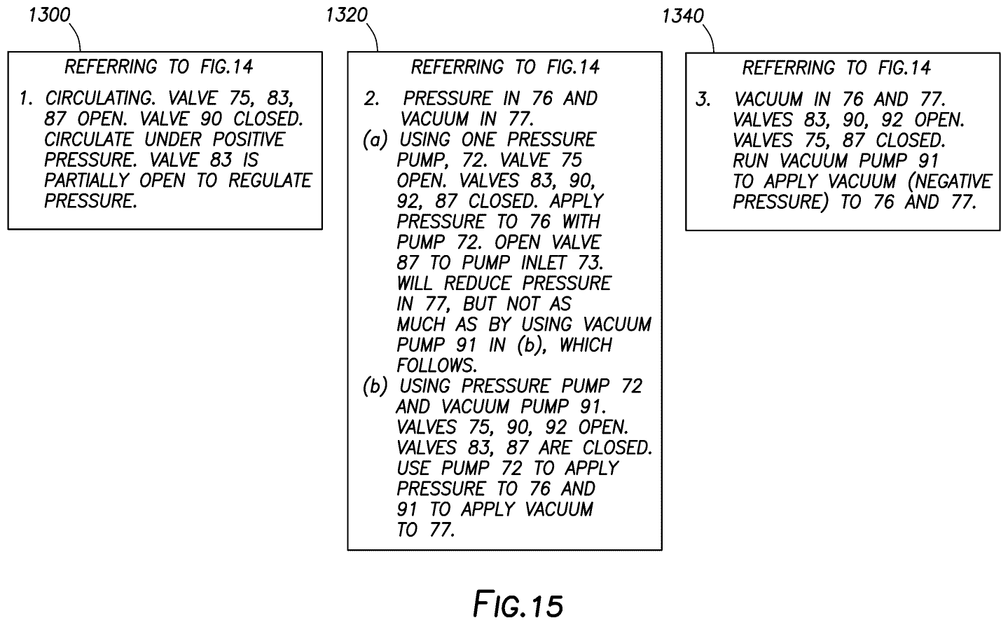

FIG. 14 depicts an embodiment of FIG. 13 wherein Z=0. There is a feed section comprised of pump 72. In some embodiments, 72 is an air pressure pump. Line 71 depicts the air line for an air compressor type pump. In some embodiments, 72 is a spinning vane type pump. The circulating section is comprised of two vessels. Pump 72 pressurizes the fluid to circulate through the system. Pump 72 has an inlet side (73, relatively lower pressure) and an outlet side (74, relatively higher pressure). Pump 72 is in removable communication with vessel 76 through valve 75 and port 78. Port 80 is equipped with a dip tube 79. Dip tube 79 extends to within about 95 percent of the height of vessel 76. Dip tube 79 is in removable communication with line 81, pressure gauge 82, valve 83 and vessel 77 through port 84.

Dip tube 85 extends through sealed opening 86 into vessel 77. Dip tube 85 extends to within about 95 percent of the height of vessel 77. Dip tube 85 is in removable communication with line 95 through valve 87. Line 95 leads back to pump inlet 73. Port 86 is in communication with line 89, valve 90, and vacuum pump 91. The line from valve 92 can be used to deliver one or more fluids to any one or more of (a) the atmosphere, or (b) a holding tank (not shown), or (c) from the holding tank, then to pump inlet 73, or alternatively (d) directly to pump inlet 73.

The embodiment depicted in FIG. 14 may operate in at least three different modes as shown in FIG. 15. For example, a circulating mode is shown in box 1300. Circulating fluid under positive pressure in the system depicted in FIG. 14 is accomplished with valves 75, 83 and 87 open. Valve 90 is closed. Operation of pump 72 causes pressure to build through pump outlet 74 causing pressure to build in each of vessels 76 and 77, which are in removable communication. The pressure in the system may be read through a pressure gauge 82, or any pressure sensor, for example, a wireless electronic pressure sensor. Valve 83 may be used to regulate pressure by partially opening or partially closing the valve. One way to partially open or close is to use a needle valve. In some embodiments, pump 72 applying pressure and vacuum pump 91 can be operated concomitantly as fluid moves through the system.

FIG. 15 box 1320 depicts the second of the at least three different modes of operation of the embodiment depicted in FIG. 14. This second method employs two alternatives, “2(a)” and “2(b)”. In each, vessel 76 is held under pressure and vessel 77 under vacuum. In “2(a)”, this is accomplished with only pump 72. In “2(b)”, each of pressure pump 72 and vacuum pump 91 is employed.

Considering “2(a)” in FIG. 15 box 1320 and the drawing in FIG. 14, this mode uses only pump 72. Valve 75 is open. Valves 83, 90, 92 and 87 are closed. Pressure pump 72 is used to apply pressure to vessel 76. Opening valve 87 to be in communication with pump inlet 73 through line 94 will cause pressure in vessel 77 to drop in that vessel. Generally, higher vacuum can be achieved using the alternative method “2(b)” described in the next paragraph.

Consider next FIG. 15 box 1320 “2(b)” and the drawing in FIG. 14. Valves 75, 90, and 92 are open. Valves 83 and 87 are closed. Pump 72 is in operation and applies positive pressure to vessel 76. Vacuum pump 91 is in operation and applies vacuum to 77. When the vessels are sealed sufficiently, the valves can be operated to hold any of the pressure and vacuum for a time sufficient to achieve any one or more of desired changes in color, sugar, alcohol or water content of a fluid in the embodiment depicted in FIG. 14. The pressure or vacuum may be held only on the wood pieces or on the wood pieces with liquid.

The third mode of operating the embodiment in FIG. 14 is depicted in FIG. 15 box 1340. Vacuum in 76 and 77,” and the drawing in FIG. 14, this mode involves vacuum in all vessels. For example, in the case of the embodiment depicted in FIG. 14, valves 83, 90, and 92 are open. Valves 75 and 87 are closed. When vacuum pump 91 is in operation, pressure drops (to below atmospheric, e.g. vacuum) in both vessel 76 and 77. The vessels are in removable communication. Vacuum may be held for a length of time sufficient to achieve any one or more of desired changes in color, sugar, alcohol or water content of a fluid in the embodiment depicted in FIG. 14. The vacuum may be held only on the wood pieces or on the wood pieces with fluid. The fluid exiting after valve 92 may be sent to a holding tank and returned to pump inlet 73. Alternatively, the fluid may be returned directly to pump inlet 73.

In some embodiments of a system for expediting aging of a raw distillate, any one or more of the at least three modes of operation depicted in FIG. 15 may be employed. In some embodiments, fluid may be circulated under pressure in a continuous manner. In other embodiments, a vessel, with or without fluid inside, may be held under pressure for a time without circulation. In other embodiments, one or more of the vessels may be under vacuum, with or without fluid, for a desired period of time. In other embodiments, all of the vessels may be under vacuum for a desired period of time and may contain fluid plus wood or only wood imbued with a minor amount of residual fluid. In other embodiments, circulating methods may change between any one or more of the at least three modes of operating a circulating section of the system as depicted in FIG. 15.

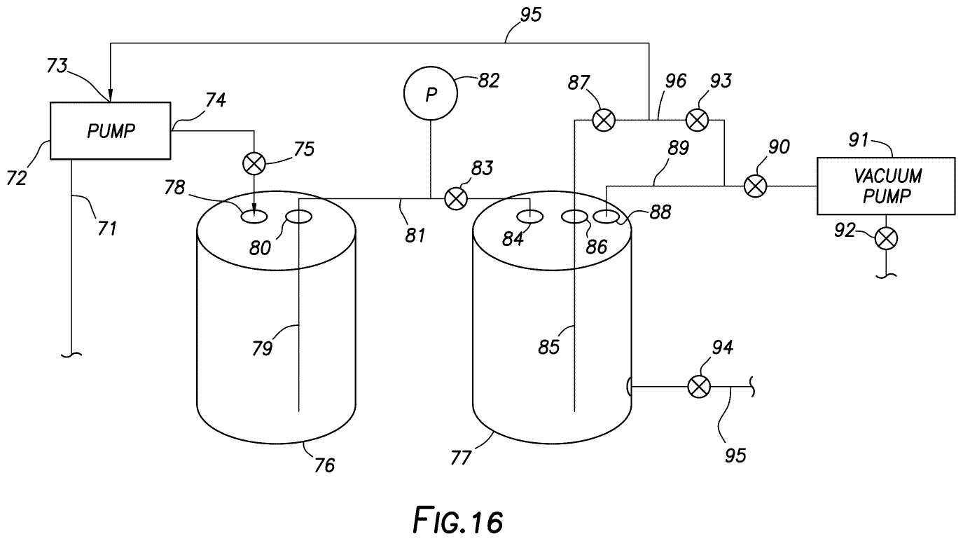

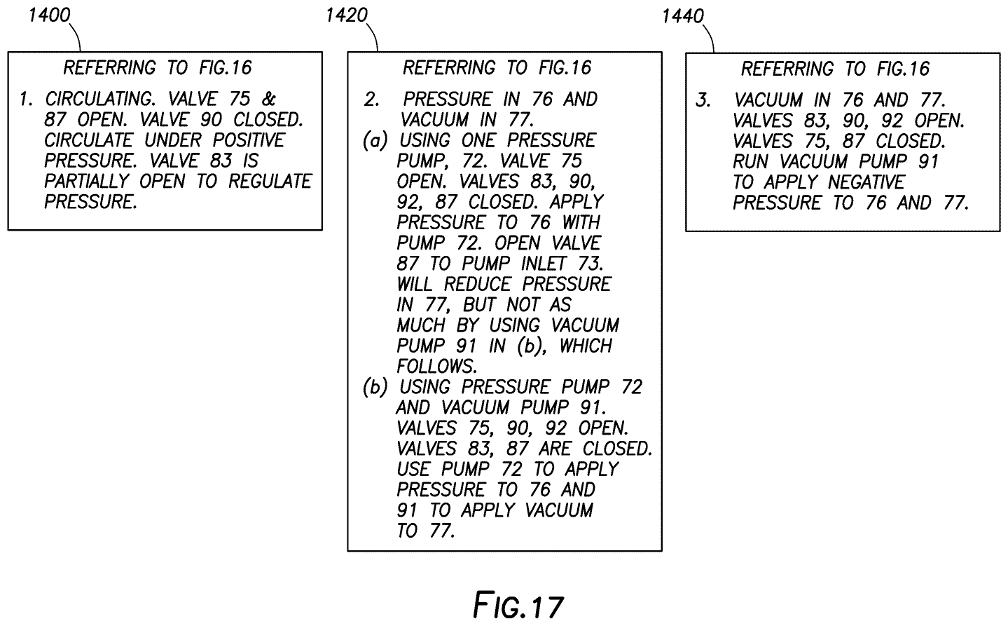

The embodiment of the system depicted in FIG. 16 can employ three modes of operation similar to those discussed above in connection with the embodiment depicted in FIG. 14 and modes of operation in FIG. 15 boxes 1300, 1320 and 1340. The embodiment depicted in FIG. 16 may be operated in any one or more of the three modes depicted in FIG. 17, boxes 1400, 1420 and 1440. The positive or negative pressure in the system may be read through a pressure gauge 82, or any pressure sensor, for example, a wireless electronic pressure sensor. Valve 94 is generally closed unless opening is required to take a sample or drain the vessel.

The embodiment depicted in FIG. 16 may be operated in a first mode shown in FIG. 17 box 1400. In that mode, valves 75 and 87 are open. Valve 90 is closed. Pump 72 provides positive pressure that allows the fluid to move in a loop through the system. Valve 83 may be used to attenuate the rate of flow and of pressure in the system.

The second mode of operation has two alternatives. Consider FIG. 17 box 1420. In “2(a)”, vessel 76 may be held under pressure and vessel 77 under vacuum using only pump 72. Using one pressure pump 72, valve 75 is open. Valves 83, 90, 92 and 87 are closed. Pump 72 causes pressure to build in vessel 76. Opening valve 87 will cause pressure in 77 to drop, but not as much as would be the case using a separate vacuum pump as in “2(b)” discussed below.

Consider “2(b)” in FIG. 17 box 1420. This is a second alternative in which vessel 76 may be held under pressure and vessel 77 under vacuum. This alternative uses both pressure pump 72 and vacuum pump 91. Valves 75, 90 and 92 are open. Valves 83 and 87 are closed. Pump 72 is used to apply pressure to vessel 76. Vacuum pump 91 is used to apply vacuum to vessel 77.

When the vessels in FIG. 16 are sealed sufficiently, the valves can be operated to hold any of the pressure and vacuum for a time sufficient to achieve any one or more of desired changes in color, sugar, alcohol or water content of a fluid in the embodiment depicted in FIG. 16. The pressure or vacuum may be held only on the wood pieces or on the wood pieces with liquid.

The third mode of operation is depicted FIG. 17, box 1440. The third mode involves vacuum in all vessels. For example, in the case of the embodiment depicted in FIG. 16, valves 83, 90, and 92 are open. Valves 75, 87, and 93 are closed. When pump 91 is in operation pressure drops in both vessel 76 and 77. The reduced pressure may be held for a length of time sufficient to achieve any one or more of desired changes in color, sugar, alcohol or water content of a fluid in the embodiment depicted in FIG. 16. The pressure or vacuum may be held only on the wood pieces or on the wood pieces with liquid.

Referring to the modes of operation in FIG. 17 and the system of FIG. 16, any one or more of the at least three modes of operation may be employed. In some embodiments, fluid may be circulated under pressure in a continuous manner. In other embodiments, the fluid may be held under pressure for a time without circulation. In other embodiments, one or more of the vessels may be under vacuum for a desired period of time. In other embodiments, all of the vessels may be under vacuum for a desired period of time. In other embodiments, the modes of operation may change between any one or more of the at least three modes of operation. The pressure or vacuum may be held only on the wood pieces or on the wood pieces with fluid.

In some embodiments of operating a system, for example as depicted in any of FIGS. 13, 14 and 16, some of the vessels may not initially be charged with wood pieces. Rather, the wood pieces may be added after one or more of the modes of operation of any of FIGS. 15 and 17 have been employed. This is referred to as additional flavor development.

Referring to, for example, the embodiment of FIG. 14, additional flavor development can be achieved by filling vessel 77 with plain or flavored charred French Oak wood pieces. In some embodiments, a wood piece may be a single wood piece. In some embodiments, a wood piece may have a spiral shape. Spiral cut wood pieces are available from Oak Infusion (www.infusionspiral.com). Preferred spirals are #3 and #4 in terms of percentage of char, those pieces being relatively more charred, for example 80 percent charred, or more.

In some embodiments, the flavored French charred oak pieces are flavored with any one or more of vanilla, coffee, port, and cola flavored soda. In some embodiments, the cola flavored soda is Coca Cola® brand cola flavored soda. A flavored charred French Oak wood piece may be prepared by soaking the wood piece in the desired flavoring agent for at least a week, preferably until the wood becomes saturated with the flavoring and no additional absorption of the flavoring the flavoring agent occurs. This can be determined by increases in the weight a wood piece over time. Occasionally, the flavoring process may be carried out under positive pressure.

In some embodiments of additional flavor development, a particular cut of wood spiral is employed. For example, a majority of the open cells of the wood structure in the spiral are oriented with the longest axis of a majority of the cells in the wood structure aligned in the same direction as the fluid flow path in a circulating embodiment.

Referring now to FIG. 7, the system may be additionally comprised of one or more aging sections. FIG. 7 depicts one repeating unit of an aging section. One repeating unit of an aging section is comprised of a third manifold line 51 equipped with valves 53 and 54; and a fourth manifold line 52 equipped with valves 55 and 56. In some embodiments, fluid is conveyed from a circulating section through second manifold line 21 and valve 22 (FIG. 6) into the aging section at manifold line 51, as follows. Aging cask 60 is in removable communication with manifold lines 51 and 52 through line 50. Line 50 is in removable communication with manifold line 51 through valve 56, port 57, connector 58 and valve 59. Manifold line 51 is in removable communication with aging cask 60 through line 50 valve 61, port 62, connector 63 and valve 64. Valves 56 and 64 may be closed to isolate an aging section from the system, disconnect and remove cask 60 in the repeating unit of the aging section through connectors 58 and 63.

FIG. 8 depicts an embodiment having three repeating units of an aging section. Manifold line 51 is in removable communication with second manifold line 21 (for example, FIG. 6) and provides a fluid flow pathway for treated fluids to enter one or more aging sections. Manifold line 52 is additionally in removable communication with equipment for blending the contents of the repeating units of one or more aging sections to create a final product.

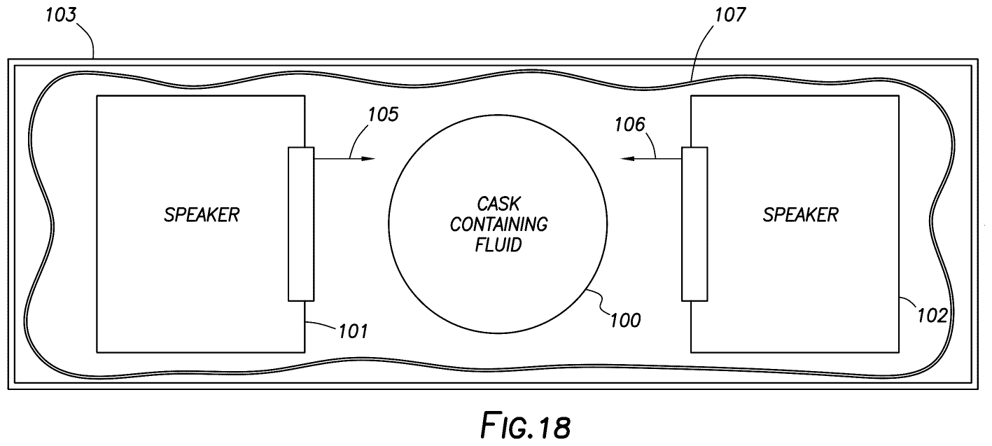

FIG. 18 depicts an embodiment of a music treatment section. At least two speakers, 101 and 102 (respectively) are placed at opposing distances from one another about wood cask 100. In some embodiments, the distances can be about 0.25 inches to about 3 inches, from about 0.6 to about 2 inches, and from about 0.75 to about 1 inch. Fluid may be conveyed to the music treatment section from the circulating section through second manifold 21. In some embodiments, the music treatment may be applied to the fluid while in the aging section. In other embodiments, the fluid is conveyed from the aging section through manifold 52 to a music treatment section as set forth in the embodiment described in the following.

Still referring to FIG. 18, wood cask 100 contains a fluid which is a distilled spirit, more preferably, a fluid treated using the systems and methods described herein. In other embodiments, additional pairs of opposing speakers may be added about the centrally disposed wood cask. The entire system is housed in a storage bin 104. In some embodiments, the storage bin is plastic. Speaker 101 is situated so that the sound output, depicted as sound wave 105 emanates towards cask 100. Speaker 102 is situated so that the sound output, depicted as sound wave 106 emanates towards cask 100 from the opposing direction with respect to sound wave 105. In other embodiments, additional speakers may be situated so that additional sound waves emanate from different directions. Paired, opposing sound wave directions are preferred but not required.

In some embodiments, blankets are employed to insulate the system from the external environment and to insulate the external environment from sound waves. Cask 100, speakers 101 and 102 are surrounded by one or more blankets inside the plastic storage bin 103. In some embodiments, one or more additional blankets for sound insulation are added to cover the top of cask 100, speakers 101 and 102. In some embodiments, a lid is placed over the top of the additional blankets. In some embodiments, the lid is comprised of plastic.

In some embodiments of music treatment, loudness levels in the range of 60 dB and 120 dB are employed. In some embodiments of music treatment, music with frequencies in the range of about 55 Hz and about 2200 Hz, or in the range of about 55 Hz and about 66 Hz, or in the range of about 1760 Hz and about 2200 Hz, or any combination of one or more of the aforementioned range or sub-ranges of frequencies. In some embodiments, a quiet period between the combinations of frequencies and loudness levels, including all ranges and sub-ranges, may be employed. A quiet period, is a period wherein one or more speakers do not transmit sound waves. In some embodiments, the quiet period for any one speaker is not longer than five seconds in duration. All individual values and subranges from equal to or greater than the foregoing and equal to or less than foregoing (in this paragraph) are included herein and disclosed herein. In yet other embodiments of music treatment, one or more microphones for transmitting sound may be included in a treatment cartridge.

### I. General Experimental

The percentage by volume ethanol content of the distillates to be used are generally in the range of 60 and 80, 80 and 90, 80 and 87, and 80 and 84. All individual values and subranges from equal to or greater than 60 percentage by volume ethanol and equal to or less than 90 percentage by volume ethanol are included herein and disclosed herein. In the prophetic and working examples described below, the distillate is simply referred to as fluid.

The valves used in the embodiments depicted by any one or more of FIGS. 1-18, may be any of variable position or simple open/close type. Temperatures will be measured and stated in degrees Fahrenheit (degrees F.) unless otherwise indicated. Pressures will be measured and stated in units of psig as though measured at room temperature, typically 78 degrees F. All individual values and subranges of the temperatures and pressures stated in this disclosure are included herein and disclosed herein.

Unless otherwise stated, the system and process are operated in the temperature range of 50 degrees F. and 90 degrees F., or 70 degrees F. and 85 degrees F., or 75 degrees F. and 80 degrees F. Unless otherwise stated, the system and process operate within the following pressure ranges: about −14.7 psig to about 400 psig, about −14.7 psig to about 300 psig, about −10 psig to about 250 psig, about −8 psig to about 220 psig, about −5 psig to about 210 psig, about 0 psig to about 200 psig.

The ports referred to herein may be for providing for sampling access. Alternatively, ports may be used to house one or more in-line sensors for monitoring any one or more of temperature, pressure, colorimetric attributes (including light transmission), density, density by gravimetry or hydrometry, infrared (IR) spectrum, refractive index (RI), ultraviolet (UV), gas chromatography (GC) analysis (including thermal or flame ionization detectors), gas chromatographic mass spectrometry (GCMS), liquid chromatography (LC), liquid chromatography/mass spectrometry (LCMS), sugar content analysis and alcohol content analysis. Chromatographic characterization of samples taken before, during and after use of the system and processes described below may be carried out as described in U.S. Pat. No. 6,132,788, titled Oak Aged Alcoholic Extract, by Zimlich, (issued Oct. 17, 2000), hereby incorporated by reference in its entirety.

In-line monitoring of alcohol content may be made with an Anton Parr L-Sonic 5100 analyzer. Colorimetric analysis may be made with any of a Portable Color Analyzer Digital Precise Colorimeter Color Difference Meter Tester 8 mm CIELAB CIELCH Display Mode DE Lab Formula, FRU brand WR series colorimeter available from www.wavegd.com, or a Hunter Labs SpectraTrend HT, with a an online cPAT type system with Hunter Lab's Easy Match QC process and software.

Process endpoints may be determined by any one or more of the following methods: (1) taste and aroma characteristics by any one or more of subjective methods such as one or more humans, for example a human flavor panel, or more objectively with electronic nose and electronic tongue type sensor arrays, each available from Alpha MOS at www.alpha-mos.com (Heracles smell analysis, https://www.alpha-mos.com/heracles-smell-analysis), and electronic tongue sensors (Astree taste analysis, https://www.alpha-mos.com/astree-taste-analysis), (2) measuring one or more properties of a desirable aged distillate, for example Pappy Van Winkle brand distilled spirits or other higher price point commercially-available aged spirits (a reference sample property or properties) and operating an embodiment of a system or process herein, while monitoring one or more of the same properties as the reference sample, until the same or substantially similar properties are obtained when starting from a raw distillate, or (3) monitoring over time the changes in one or more properties of a raw distillate treated using the systems and embodiments herein and stopping the process when a selected property value does not change further with additional cycles through a process or system.

As an example of monitoring for an endpoint in the third option above, a selected property may not change by more than 4% from the same property measurement made one step prior in a system or process, alternatively may not change by more than 3%, alternatively may not change by more than 2%, alternatively may not change by more than 1.9%, alternatively may not change by more than 1.8%, alternatively may not change by more than 1.7%, alternatively may not change by more than 1.6%, alternatively may not change by more than 1.5%, alternatively may not change by more than 1.4%, alternatively may not change by more than 1.3%, alternatively may not change by more than 1.2%, alternatively may not change by more than 1.1%, alternatively may not change by more than 1.0%. In still other embodiments, the measured property may not change by more than 0.9% than that same measurement made one step prior in a system or process, or alternatively may not change by more than 0.8%, or alternatively by more than 0.7%, or alternatively by more than 0.6%, or alternatively by more than 0.5%, all relative to that same measurement made one step prior in a system or process. All individual values and subranges of any one or more of end point desirable product characteristics including water, alcohol, sugar and color (including light transmission) stated in this disclosure are included herein and disclosed herein.

Connectors may be quick disconnects, or other simple threaded types of arrangement. Quick connections are preferred for the expeditious isolation and changing of treatment cartridges during operation of the embodiments of the system disclosed herein, including those of the treatment section during one or more circulating steps or holding vacuum or pressure steps. The quick connects are one way of providing removable communication for the systems and processes described herein.

Wood swelling analysis may be conducted according to the procedure stated in any of (1) P. Hohnel and K. Tauer in Studies On Swelling of Wood With Water and Ionic Liquids, Wood Sci Technol (2016) 50:245-258, and (2) G. I. Mantanis, R. A. Young and R. M. Rowell in Swelling of Wood Part 1. Swelling In Water, Wood Sci. Technol. 28:119-134 (Springer Verlag 1994). The moisture content of wood or of wood pieces may be determined by the methods disclosed by Carl A. Eckelman in The Shrinking and Swelling of Wood and Its Effect on Furniture, Purdue University—Forestry & Natural Resources Cooperative Extension Service West Lafayette, Indiana available at https://www.extension.purdue.edu/extmedia/FNR/FNR-163.pdf. Wood piece analysis may be made by microscopic analysis. Char may be estimated using computer image analysis or by visual estimation. Alternatively, custom wood pieces may be ordered from Seguin Moreau Napa Cooperage, 151 Camino Dorado, Napa California 94558, United States.

The wood pieces may be any one or more of baked wood, freeze-dried wood, charred wood, oven-roasted wood, flame-roasted wood, burned wood, dehydrated wood, dried wood, raw wood (see, e.g., col. 8 in international patent application number PCT/US/2009/059984 by Daniel Martin Watson filed on Oct. 8, 2009), pulverized wood, boiled wood, supercritical fluid extracted wood, burned wood, hydrolyzed wood, enzyme-treated wood, lignin enzyme treated wood, genetically modified wood, selectively bred wood, and combinations thereof. The prior mentioned PCT/US/2009/059984 is hereby incorporated by reference in its entirety.

The wood pieces are comprised of white oak, French oak, flavored white oak, flavored French oak, and combinations thereof.

For music treatments, sound wave frequency is expressed herein in Hertz (Hz). Sound loudness is expressed in decibels (dB). The decibel (dB) levels were measured with a new BAFX3370 decibel meter available from Amazon and BAFX Industries.

### WORKING EXAMPLES

### Working Example A. Embodiment of a Feed Section & Circulating Section

The embodiment of the system depicted in FIG. 14 was employed in this example. A reference sample of traditionally aged distillate with acceptable flavor and aroma profiles was measured for color in a colorimeter. The colorimeter was a Portable Color Analyzer Digital Precise Colorimeter Color Difference Meter Tester 8 mm CIELAB CIELCH Display Mode DE Lab Formula. The reference sample was Meyers Original Dark Rum, 80 proof. The light transmission value of the reference sample was 3.4 lumens.

The feeding section was comprised of pump 72, pump outlet 74 and valve 75 as shown in FIG. 14. The feeding section did not have a separate holding tank. Instead, the vessels were charged directly with fluid and wood pieces. The fluid was a sugar-derived raw distillate obtained from the Telluride Distilling Company located at 152B Society Drive, Telluride CO 81435. The fluid was approximately 80 proof.

Vessels 76 and 77 were made of stainless steel and had a volume capacity of about 2500 ml. The approximate volume of fluid filled into each vessel was 2500 ml for a total fluid volume in the system of about 5,000 ml.

Each vessel was charged with wood pieces. The wood pieces were charred oak staves. The approximate weight of the wood pieces used was 453 grams. The dimensions of the wood pieces were about 4 in. long, and 0.75 in diameter. The percentage char of the wood pieces was about 80 percent. An amount of uncharred wood is needed to prevent the wood pieces from crumbling during the process.

The process was performed as follows: Valves 75 and 87 were opened with valve 83 partially open. Valve 90 was closed. Pump 72, an air pressure pump, was activated to allow circulation of the fluid through the system under positive pressure. Pressure was maintained at approximately 60 psig when circulating the fluid in a loop through the system by partially closing valve 83. Valves 75 and 83 regulated pressure in vessel 76. By closing both valves, pressure can be held in vessel 76. By opening valve 90 and 92, both vessels 76 and 77 could be exposed to atmosphere. Although neither were done in this experiment.

Samples were taken from the system periodically as shown in Table 1. Pump 72 was turned off. The samples were taken by removing the top of one of the vessels and withdrawing a portion of the liquid. The top was then replaced and the system returned to circulating mode under pressure (about 60 psig) until the next sample was taken from the system in like manner.

Table 1 below shows the changes in the light transmission and color characteristics of the samples taken at the time taken from the system.

TABLE 1
Light Transmission Values For Working Example A

| time | Light | a | b |
|---|---|---|---|
| hours | lumens | see note >> | |
| 0.5 | 20.06 | 4.26 | 1.17 |
| 1 | 19.67 | (4.91) | 15.37 |
| 2 | 19.67 | (5.20) | 12.78 |
| 3 | 19.48 | (1.05) | 11.00 |
| 4 | 19.26 | 2.33 | (0.70) |
| 5 | 18.8 | 1.93 | (0.05) |
| 6 | 16.8 | 1.86 | 1.99 |
| 7 | 13.84 | 4.35 | 0.43 |
| 8 | 12.45 | 4.26 | 1.17 |
| 9 | 11.66 | (4.91) | 16.05 |
| 10 | 10.1 | (5.24) | 12.57 |
| 11 | 7.48 | 4.26 | 1.17 |
| 12 | 5.89 | (4.35) | 15.37 |
| 13 | 4.6 | (5.24) | 11.57 |
| 14 | 3.6 | 4.26 | 1.17 |
| 15 | 3.44 | (4.67) | 16.47 |
| 16 | 3.41 | (5.48) | 13.66 |

In Table 1 above, light transmission is expressed in lumens in the first column.

The second and third columns provide light transmission in limited sections of the color spectrum according to the following: (1) In the second column, “a” is the difference between red and green (numbers on the plus side are more red, minus side more green), and (2) In the third column, “b” is the difference between blue and yellow. numbers on the plus side are more blue, minus side more yellow. The lower values of light (lumens) over time show that as the liquid became darker, it transmitted less light resulting in a lower lumen value. Table 1 shows the lumen value at hour 15 was 3.41. This is substantially similar to the value of the reference sample, measured as 3.4. This shows that one way of measuring and monitoring for process end points is by measuring the property of the raw distillate being treated in the process as compared to a property measured from a reference sample that represents a desirable relatively higher price point commercially available aged distillate (aged by traditional slow methods).

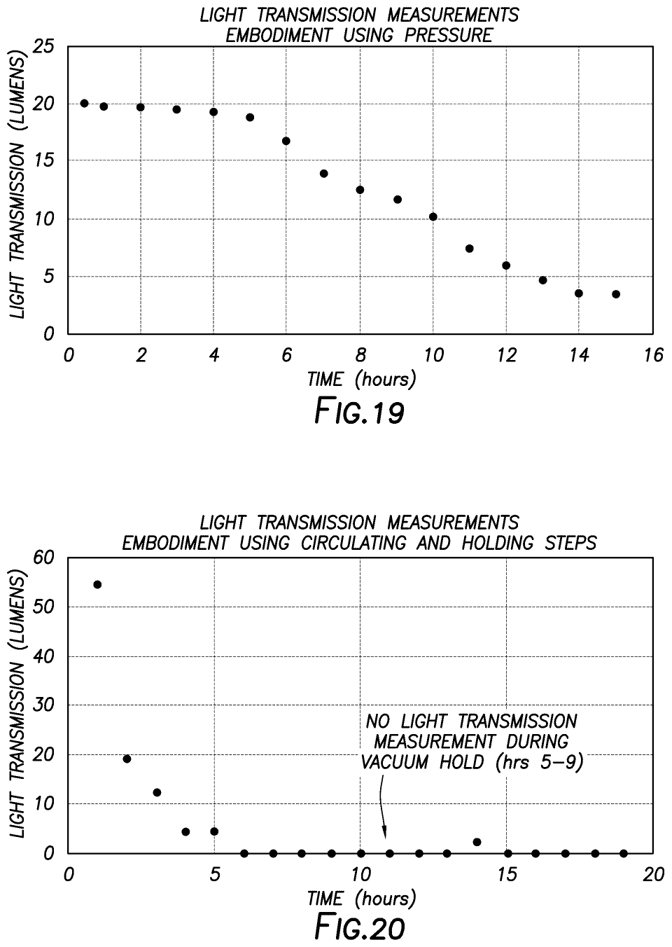

FIG. 19 shows light absorption in lumens along the y-axis. Time (in hours) from the beginning of the circulating step is displayed along the x-axis. The time denotes the time the sample was taken from the system (time =zero is the time the circulating step began). Color measurements were made immediately after the sample was removed from the system. FIG. 19 shows that the color did not change more than 2% after the fourteenth hour of the circulating step.

FIG. 19 also shows that it is possible to monitor and detect the end point of the process by measuring the rate of change of a selected fluid property over time. The lumen value of the fluid under treatment did not change more than two percent compared to its immediately prior measured value.

As to monitoring color, taste and aroma of the treated fluid, visual inspection of the sample at hour 15 showed a pleasing clear brown liquid. The aroma and taste of the sample was comparable to bourbon or dark rum and was considered comparable to higher price point aged spirits that are commercially available.

Blind taste and aroma tests were conducted to determine if others could tell the difference between the reference sample and the test sample. Five individuals were selected at random from a group of ten individuals total. In a blind taste test, eighty (80) percent of the individuals could not correctly indicate which sample was the commercially available reference sample and which was the test sample.

After hour 16, the circulating step under pressure was stopped. Instead, negative pressure was applied to both vessels, 76 and 77 using vacuum pump 91. The process was to close valves 75 and 94, completely opening valve 83 and 90 and then engaging the vacuum pump 91 to pull −3 to −4 psig of negative pressure of vacuum. The entire system was allowed to reside in the mode of vacuum without circulating for 8 hours. However, no additional measurements were available to report.

### Working Example B. Embodiment of a Feed Section & Circulating Section Employing Circulating Under Pressure Step and Vacuum Hold Step

This Working Example B used the same apparatus, amount of raw distillate fluid, amount and type of wood as in Working Example A above. The fluid was a sugar-derived raw distillate obtained from the Telluride Distilling Company located at 152B Society Drive, Telluride CO 81435. The fluid was approximately 80 proof. The reference sample was Makers Mark Bourbon and had a total lumen value (not shown in the table) of 60.11 as measured with a FRU brand WR series colorimeter.

The fluid was circulated under 60 psig of pressure. Samples were taken from the apparatus as in Working Example A at hours 1, 2, 3, and 4 during circulation. During the sampling process, the system was at atmospheric pressure for usually 6-8 minutes. The amount of light transmission of each sample taken, expressed in lumens, was measured and recorded. The light transmission values did not continue declining after this period of circulation, as demonstrated in Table 2 and as depicted graphically in FIG. 20. Therefore, the light transmission values did not change by more than two percent relative to a prior measurement.

After the circulating step above (in hours 1-4 above), a vacuum was applied to the system (with the containing the liquid and wood inside) for nine consecutive hours. The vacuum was approximately −3 to −4 psig. A sample was taken and its light transmission value measured. The light transmission value did decline further as indicated in Table 2 and FIG. 20.

The system, still with the same fluid and wood pieces inside, was returned to the circulating mode for approximately an additional thirteen hours under 60 psig pressure. An additional decline in light transmission, of approximately 4% over the prior value was measured. The process was stopped when the total transmission value of the fluid in the system was measured to be 60.18, which was considered substantially similar to the reference value of 60.11.

The taste of the fluid from this working example was strong in alcohol.

TABLE 2
Light Transmission Values For Working Example B

| | | | |
|---|---|---|---|
| | System | Light | % Change in |
| Time | Pressure | Transmission | Light |
| (hrs) | (psig) | (Lumens) | Transmission |

| | | | | |
|---|---|---|---|---|
| Time | 60 | | 54.7 | |
| 1 | 60 | | 19.08 | −549.69% |
| 2 | 60 | | 12.63 | −15.32% |
| 3 | 60 | | 4.59 | −16.56% |
| 4 | 60 | | 4.59 | 0.00% |
| 5 | −0.15 | NR | | |
| 6 | −0.15 | NR | | |
| 7 | −0.15 | NR | | |
| 8 | −0.15 | NR | | |
| 9 | −0.15 | NR | | |
| 10 | −0.15 | NR | | |
| 11 | −0.15 | NR | | |
| 12 | −0.15 | NR | | |
| 13 | −0.15 | | 2.28 | −4.08% |
| 14 | | NR | | |
| 15 | | NR | | |
| 16 | | NR | | |
| 17 | | NR | | |
| 18 | | NR | | |
| 19 | | | 0 | |

### Working Example C. Exposing a Bourbon Blend to Music

In this working example, a blend of bourbons was employed. The blend was made from the constituents and amounts shown in Table 3 below.

TABLE 3
Working Example C Music Exposure Starting Fluid Blend

| Ingredient | Amount |
|---|---|
| Elija Craig Bourbon | 1.75 L |
| Makers Mark Bourbon | 1.75 L |
| Bernheim Bourbon | 0.75 L |
| Wellers Bourbon | 0.75 L |

The fluids in Table 3 were blended together using the proportions indicated. The resulting blend will be referred to as “bourbon” in this working example. The proof of the bourbon was measured and determined to be 85 proof. A control sample not exposed to music (“NME”, no music exposure) was retained in a glass bottle for use in a blind taste test detailed further below.

The bourbon to be exposed to music (“ME”, music exposure) was placed into an older washed 2-liter cask made of Charred American Oak filling the cask about ⅞ths full. The cask had been previously dried out, then reconditioned for 36 hours in a hot water soak at about eighty-five degrees F. The soak removed some of the charred layering in the cask.

The cask was placed in the center of a large plastic storage bin with an HDX27 gallon storage tote available commercially model #5/205978361 Each speaker was placed ¾ inches away from the cask with the output side of the speaker facing the cask and each speaker opposing the other with the cask between. The cask-and-speakers assembly was covered with two layers of folded blankets. The plastic bin was covered with its lid. The lid was then covered with an additional blanket.

The bourbon in the cask was exposed to various types of music as detailed in Table 4 below. Music with alternating series of frequencies was employed. In particular, the music employed had a wide range of frequencies. For example, music with frequencies in the range of 220 Hz and 2200 Hz was employed. As another example, music in the range of 220 HZ and 2200 HZ wherein there is no more than 0.5 seconds of quiet time (no music) can be employed. As yet another example, music in the 220 and 2200 Hz frequency range can be employed wherein the frequencies at the lowest 20% and highest 20% of the frequency range. This range is preferable. All individual values and subranges from equal to or greater than the foregoing and equal to or less than foregoing (in this paragraph) are included herein and disclosed herein. The decibel (dB) levels were measured, from time to time, with a new BAFX3370 decibel meter available from Amazon and BAFX Industries. The range of observed db levels was 78 db and 110. For example, a Samantha Fish CD produced approximately 110 db.

TABLE 4
Music Exposure

| Day | Total Time | | Type of Music/Source |
|---|---|---|---|
| Feb. 27, 18 | 8.5 | hours | CD's playing: Manheim |
| | | | Steamroller, Dave Brubeck, |
| | | | Samantha Fish, Howard Jones |
| | | | and Duke Ellington to name a |
| | | | few examples |
| Feb. 28, 18 | 11.5 | hours | Same as above |
| Mar. 1, 18 | 14.75 | hours | Local Radio Rock Station |
| Mar. 2, 18 | 16 | hours | Local Radio Rock Station |
| Total | 52.75 | hours | |

A blind tasting of the NME and ME samples of bourbon was conducted. About 12 ml of each of the ME and NME bourbon was poured into a separate glass. The taster was not allowed to know which sample was NME and which was ME.

The ME bourbon sample was dark and rich in color and not cloudy. It had a warm aroma with spice on the back end. Vanilla and caramel dominated. There was some sediment. On the tongue: Fire with a touch of bitterness on the front end. The bitterness was not noticeable on the first taste.

A few drops of water were added to the ME bourbon sample described above and the sample was tasted again. The drops of water released tastes of vanilla. The sample was described as warm, well-rounded alcohol considered very nice.

The NME bourbon sample was moderately dark and rich in color. Slight charred aroma of a small piece of sediment. Moderate alcohol aroma, not unpleasant, mostly like ethyl acetate and perhaps vanilla. Warm taste. Well rounded.

The blind taste test results overall indicated that the ME sample (the one exposed to music with the alternating ranges of high and low frequencies) applied at a range of about 78 and 110 dB was much preferred over NME bourbon, which was not exposed to music.

### Working Example D. Exposing a Scotch Blend to Music

This working example on a Scotch Blend used the same type of charred American Oak cask (except 5 L volume), used only once, as in the Example C above.

TABLE 5

| Ingredient | Amount |
|---|---|
| McClelland's Highland Single Malt, 80 proof | 1.75 L |
| Blend of bottoms from various bottles of Scotch | 3.0 L |
| (including McClelland's described above) | |

About 150 L of the blend in the table above was drained out and held as the control NME sample. The cask was allowed to stand about one week. Then, the cask was exposed to music using the same procedure and apparatus as described above in the working Example B. The total time exposed to music was 78 hours at 100 dB, followed by 36 hours of resting.

As in Working Example C above, a blind tasting was conducted. The NME sample was very smooth in aroma and taste. Warm fire in mouth. With water add, took on a little bitterness. The ME sample was “YUM!”. Butterscotch and caramel, warm heat, but no detectable burn. With water add, a little more fire, but still the sweet ends were tasted.

### II. Prophetic Example One

Prophetic Example One described below is comprised of the steps of (1) feeding, (2) circulating through at least one treatment section comprised of one or more repeating units, (3) monitoring, and (4) aging. The circulating step may employ any one of four circulating system embodiments. For example, in FIG. 6, line 35 out of tank 1 may return to any of: (a) line 11 (shown), (b) line 2 (not shown), (c) line 6 (not shown), or (d) tank 1.

Feeding Step. Referring to FIG. 6, fluid will be pumped under pressure using pump 5 from tank 1 through line 2, open valve 3, port 4, through pump 5, into line 6 and through open valve 7. Valves 27, 16 and 40 are closed. Valves 8 and 12 are in the open position. Fluid will flow from first manifold line 24, through connector 10, line 11, open valve 12, port 13 and into treatment cartridge 14.

The treatment cartridge 14 contains American Oak wood pieces. Some wood pieces are charred and some are not charred. The ratio of charred to uncharred wood pieces is in the range of 4 (charred) to 1 (uncharred) and 8 (charred) to 1 (uncharred). The range of sizes of the wood pieces is 0.75 cubic inches and 3 cubic inches. Within the size range, relatively larger wood pieces are not charred, or are relatively less charred compared to smaller pieces.

The fluid flows through treatment cartridge 14 thereby exposing the fluid to the contents of treatment cartridge 14. The fluid is circulated through port 17, open valve 18, and through connector 19 into the second manifold line 21. Valve 8 is then changed from the open position to the closed position.

Valve 22 is closed and valve 23 is open. Pump 29 operates to apply a vacuum to cartridge 14 pulling fluid from cartridge 14 and into the second manifold 21. Pump 29 conducts fluid into line 28 and forces the fluid through line 30, open valve 31, port 32, open valve 33, and connector 34.

Circulating Step. Various embodiments for the circulating step of the process are described below.

Circulation Embodiment 1 (as shown in FIG. 1). Pump 29 pumps the fluid through open valve 38 and circulates the fluid through connector 39 and open valve 40. With valves 8 and 27 in the closed positions, the fluid circulates again through open valve 12, port 13 and into treatment cartridge 14. The fluid flows through treatment cartridge 14. Valve 16 is in the closed position. The fluid passes through port 17, through open valve 18, across connector 19 and into the second manifold line 21. The fluid flow in this embodiment is continuously repeated with monitoring, which is described separately below. The number of trips around the loop during circulation can be monitored by measuring fluid flow with a flow monitor at any one or more of ports 4, 13, 15 and 17. Volume flow relative to the total system volume is an indicator of the number of times the fluid circulates through the system, and more particularly, through any given treatment cartridge. This same principle can be used to count the times fluid flows through they system, or any particular sub-system or treatment cartridge therein.

Circulation Embodiment 2 (as shown in FIG. 1). In this embodiment, assume there is no dotted line 37 or valve 38. Instead, pump 29 pumps the fluid through open valves 31 and 33, port 32, past connector 34 and returns the circulated fluid to tank 1 through open valve 36.

Valve 23 is changed from the open to the closed position. Valve 8 is changed to open from the closed position. Pump 5 continues the process of circulating the fluid through the system by pumping fluid through line 2, open valve 3, port 4, out of pump 5, into line 6, through open valve 7 and open valve 8 into the first manifold line 24. Valve 27 is in the closed position again forcing the circulated fluid into at least one repeating unit of the treatment section, for example, treatment cartridge 14.

Circulation Embodiment 3. This embodiment is depicted in FIG. 6. Valve 8 is changed from open to a closed position. Pump 29 is a spinning vane pump having a higher pressure side and a lower pressure side. Pump 29 pumps fluid out of the second manifold line 21 through open valve 23, into line 28. The lower pressure side of the pump is in removable communication with the second manifold line 21. The higher pressure outlet side of the pump 29 is in removable communication with tank 41. From the outlet side of pump 29, the circulated fluid enters line 30, open valve 31, port 32, open valve 33, through connector 34 and enters circulating tank 41. Circulating tank 41 is optionally fitted with one or more stirring devices including impeller type stirrers similar to that depicted in FIG. 2 for tank 1.

Pump 29 recirculates the circulated fluid out of tank 41, through open valve 42 and connector 44 through line 35. Valve 31 is open forcing the fluid into line 11, through connector 39, open valve 40, open valve 12, through port 13. Valves 8, 27 and 16 are closed forcing the flow pathway back through treatment cartridge 14.

Circulation Embodiment Number 4. The same process as in Circulation Embodiment Number 3 (first paragraph) is employed except that pump 29 is configured to apply vacuum across treatment cartridge 14. Valve 23 is closed and the wood pieces are held in treatment cartridge 14 under vacuum for a period of time while the fluid is in tank 41. Then, pump 29 recirculates the circulated fluid out of tank 41, through open valve 42 and connector 44 through line 35. Valve 31 is closed forcing the fluid into line 11, through connector 39, open valve 40, open valve 12, through port 13. Valves 8, 27 and 16 are closed forcing the flow pathway back through treatment cartridge 14.

Any of the circulating embodiments described above may be repeated as many times as necessary in accord with the process monitoring described below to reach the desired analytical results as described below. The process monitoring may be by sampling through a port, or by in-line monitoring of the process through a port.

Monitoring. The chosen circulation embodiment is repeated under the specified conditions while monitoring by any one or more of ports 13, 15, 17 and 32 for a desirable flavor profile, a desirable aroma profile, density, alcohol content, and color by spectrophotometry or by colorimetry (for example, light transmission value/lumen value). The chosen circulation embodiment is continuously repeated until at least: (a) the flavor profile, aroma profile is acceptable whether measured subjectively or objectively against a reference, (b) the fluid in the system attains at least one property that is the same or substantially similar to a desirable higher price point commercially available aged distillate, or (c) the fluid in the system does not change more than 2% relative to that same measurement made in the immediately prior measurement in the immediately prior trip circulating through the system. For example, as to this last option (c), the color or brown color (or light transmission measured with a colorimeter) of the fluid does not darken more than an additional 2% after repeating one additional circulating step through the system (for example, the system depicted in FIG. 1 or 6).

Aging Step. From the chosen circulating option, valve 23 is changed from the open position (used when circulating) to a closed position. Valve 22 (in the second manifold line 21) is changed from the closed position to an open position. Pump 5 pumps the circulated fluid out of manifold line 21 into one or more repeating units in an aging section (for example, as shown in FIGS. 7 and 8 aging segments. In this example, Y=1. The circulated fluid enters into manifold line 51 from the outlet side of pump 5 through open valve 53 (valve 58 is closed).

Pump 5 pushes the circulated fluid through line 50, open valve 56, port 57, connector 58 and open valve 59 into aging cask 60. (In the case of Y=3 as shown in FIG. 8, the fluid flow would simply be through all repeating units including those with the letters “a” and “b” appended to the numbered items.)

Aging cask 60 is made of American Oak. The aging process is monitored as described above in the “Monitoring Step.” The aging step is ended and the final product is packaged or blended then packaged, based upon achieving the desired test results

### III. Prophetic Example Two

Prophetic Example Two described below is comprised of the steps of (1) feeding, (2) circulating through at least one treatment section comprised of one or more repeating units, (3) monitoring, (4) applying and holding any one or more of vacuum or pressure on any one or more of the repeating units in the treatment section, (5) repeating one or more of the steps (i) circulating, (ii) monitoring, (iii) applying and holding the pressure or vacuum, and (6) aging in one or more repeating units in one or more aging sections.

Feeding Step. Referring to FIG. 2, pump 5 will pump fluid under pressure from tank 1, through line 2, open valve 3, port 4, through pump 5, into line 6 and through open valve 7 as shown in FIG. 2. Referring to a system of the type in FIG. 6 but with two treatment sections as depicted in FIG. 9, valve 8 is in the open position to allow entry of the fluid into the first manifold line 24. Referring to FIG. 9, valves 27, 27a, and 40 are closed. Valves 16 and 40a are open forcing the fluid under pressure through connector 10, open valve 12, port 13 and into treatment cartridge 14 and then further through line 11, connector 39a, valve 40a, valve 12a, port 13a and into treatment cartridge 14a. Valve 16a is closed so as to force fluid flow through cartridge 14a and out port 17a, valve 18a, and connector 19a in in line 20 leading into second manifold line 21. Valve 22a is closed to prevent fluids from flowing into the aging section.

Circulating Step. In this example, and except for the modifications described in this section, the procedure to be employed is the same as that previously described above in Prophetic Example One, Embodiment 3 of the Circulating Step. Assume, as described above, that there are two repeating units in the treatment section as depicted in FIG. 9.

Valve 8 (for example, as shown in FIG. 6) is changed from open (as used in the feeding step described above) to a closed position. Referring again to FIG. 9, valve 22a is closed and valve 23 changed from closed to open. Pump 29 (not shown in FIG. 9) pumps circulated fluid out of the second manifold line 21 through open valve 23, into line 28 (not shown in FIG. 9, but shown in FIG. 6). Referring to FIG. 6, the fluid enters line 30, open valve 31, port 32, open valve 33, through connector 34 and enters circulating tank 41. Circulating tank 41 is optionally fitted with one or more stirring devices including impeller type stirrers similar to that depicted in FIG. 2 for tank 1.

Still referring to FIG. 6, pump 29 (or if needed, an additional pump not shown) moves the fluid out of tank 41, through open valve 42 and connector 44 through line 35. Valve 31 is closed forcing the fluid into line 11, through connector 39, open valve 40, open valve 12, through port 13 and once again into treatment cartridge 14. Recalling that X=2 as shown in FIG. 9, and with valves 8 and 27 closed (FIG. 6), circulated fluid flows through line 11 (FIG. 9) and open valve 16, through connector 49a, valve 40a, valve 12a and port 13a and into cartridge 14a.

Still referring to FIG. 9, valve 16a is closed forcing the circulating fluid through port 17a, valve 18a, connector 19a and into second manifold line 21. Valve 22a is closed. Valves 23a, 22 and 23 in the second manifold line 21 are open. Pump 29 (e.g., FIG. 6) pumps circulated fluid out of the second manifold line 21. The circulated fluid enters line 30, open valve 31, port 32, open valve 33, through connector 34 and enters circulating tank 41. The circulated fluid is stirred with a stirrer as it moves through tank 41.

Monitoring While Circulating. Still referring to FIG. 9, circulating is repeated under the specified conditions while monitoring by any one or more of ports 4, 13, 15, 17 and 32 for taste desirable flavor profile, desirable aroma profile, density, alcohol content, and color by spectrophotometry and colorimetry.

The chosen circulation embodiment is continuously repeated until at least: (a) the flavor profile, aroma profile is acceptable whether measured subjectively or objectively against a reference, (b) the fluid in the system attains at least one property that is the same or substantially similar to a desirable higher price point commercially available aged distillate, or (c) the fluid in the system does not change more than 2% relative to that same measurement made in the immediately prior measurement in the immediately prior trip circulating through the system. For example, as to this last option (c), the brown color (or light transmission measured with a colorimeter) of the fluid does not darken more than an additional 2% after repeating one additional circulating step through the system (for example, the system depicted in FIG. 1 or 6).

Applying and Holding Vacuum Step. Referring to FIG. 6 and assuming two treatment cartridges, valves 8, 27 and 16 are closed. As much fluid as possible is pumped out of the system with pump 29 (using pump 29 as a vacuum, source of reduced pressure operating on the treatment cartridges). Care is taken to minimize the loss of volatile components of fluid in the system. Valve 23 is closed, leaving the system under a vacuum. The vacuum is held for a time period in the range of ½ to ¾ of the total time spent immediately prior in circulating. The vacuum pressure ranges: about −14.7 psig to about 0 psig, about −14.7 psig to about −1 psig, about −10 psig to about −2 psig, about −8 psig to about −3 psig, about −5 psig to about −4 psig, about −3 psig to about 0 psig.

One or more additional circulating steps and applying and holding vacuum steps are repeated in an alternating fashion while monitoring as previously described in Prophetic Example 1. These alternating steps, with accompanying monitoring, are repeated until the color of the fluid or light transmission value of the fluid does not darken more (decline more) than an additional 2% after at least one, or alternatively any one or more of one, two or three additional trips through the circulating step.

Aging Step. Referring to FIGS. 8 and 9, to start the aging process, valves 22, 23a and 22a are changed from the open position used in the circulating step to a closed position. Pump 5 pumps the circulated fluid out of the second manifold line 21 into the three aging segments shown in FIG. 8.

Pump 5 pumps the circulated fluid into manifold line 51 (FIG. 8) through open valves 53, 54, and 57. Valve 58 is closed. Pump 5 pumps the circulated fluid through line 50 to fill all three aging casks 60, 60a and 60b. For example, through open valve 56, port 57, connector 58 and open valve 59 into aging cask 60. Each aging cask 60, 60a and 60b is made of newly charred American Oak.

Monitoring. The aging step is monitored as previously described in Prophetic Example 1.

### IV. Prophetic Example Three

The process of Prophetic Example 2 will be followed using a raw distillate taken from a still head (bourbon mash) or a sugar-derived raw distillate obtained from the Telluride Distilling Company. The starting proof of the raw distillate is in the range of 80 proof to 94 proof. The feeding, treating, circulating, and applying and holding vacuum steps as described in Prophetic Example 2 will be followed. The monitoring step will be employed to measure the color, particularly brown color (or light transmission by colorimeter), and alcohol content of distillate. The steps of circulating and of applying and holding vacuum in an alternating fashion as described in Prophetic Example Two will be repeated until any one or more of the following occur:

The chosen circulation embodiment is continuously repeated until at least: (a) the flavor profile, aroma profile is acceptable whether measured subjectively or objectively against a reference, (b) the fluid in the system attains at least one property that is the same or substantially similar to a desirable higher price point commercially available aged distillate, or (c) the fluid in the system does not change more than 2% relative to that same measurement made in the immediately prior measurement in the immediately prior trip circulating through the system. For example, as to this last option (c), the brown color (or light transmission measured with a colorimeter) of the fluid does not darken more than an additional 2% after repeating one additional circulating step through the system (for example, the system depicted in FIG. 1 or 6).

The aging step of Prophetic Example 2 will then be followed. The aging will be monitored by tracking the percentage change to darker color (measured by declining colorimeter light transmission values), an acceptable flavor profile or aroma profile. The fluid produced from the process steps described above will then be exposed to music according to the procedures described above in the working examples of exposure to music.

Any type of ethanol containing raw distillate may be used in the processes and systems described herein. Exemplary raw distillates being created from 70% Corn, 16% Wheat and 14% Barley. Raw distillates are available from, for example, from Bend Spirits https://www.bendspiritsdistillery.com, 19330 Pinehurst Rd, Bend, OR 97701 ((541) 318-0200 ext. 6)).

What is claimed is:

1. A system for expedited aging of a distillate comprising:
a feed section,
a treatment section,
a circulating section, wherein
the feed section is comprised of a tank and a pressure pump,
the treatment section is comprised of at least one repeating unit comprised of a first manifold, a second manifold and at least one treatment cartridge having an inlet in removable communication with the first manifold, a first outlet in removable communication with the first manifold, and a second outlet in removable communication with the second manifold,
the circulating section is comprised of a vacuum pump in removable communication with the second manifold, and a recirculating line operable to communicate fluid to any one or more of the tank, the first manifold or both,
the at least one treatment cartridge is adapted to hold wood pieces in the flow of the fluid,
the first outlet in removable communication with the first manifold is adapted for circulating the fluid in a loop through the at least one treatment cartridge and for removing the fluid from the at least one treatment cartridge so that the at least one treatment cartridge may be made substantially free of fluid other than at the most residual fluid wetting the interior surface of the treatment cartridge and any fluid imbued in the wood pieces in the at least one treatment cartridge,
the second outlet is in removable communication with the second manifold line,
the feeding section and the circulation section are adapted to cooperate to apply any one or more of pressure and vacuum to the wood pieces in the at least one treatment cartridge while the at least one treatment cartridge is substantially free from fluid other than at the most residual fluid wetting the interior surface of the treatment cartridge and any fluid imbued in the wood pieces in the at least one treatment cartridge.

2. The system of claim 1 further adapted to monitor at least one fluid property endpoint wherein the endpoint is any one or more of (a) at least one measured property of the fluid does not change more than about two percent relative to a measurement made immediately prior, (b) the measured property of the fluid is the same or substantially similar to the same measured fluid property of a reference aged distilled spirit.

3. The system of claim 2 wherein the fluid property is light transmission.

4. The system of claim 1 wherein the number of repeating units in a treatment section is between one and thirty additional repeating units wherein each additional repeating unit first manifold is in removable communication with at least one other repeating unit manifold, each additional repeating unit second manifold is in removable communication with the at least one other repeating unit second manifold, such that any one or more repeating units are operable to be in removable communication with the repeating units within a treatment section.

5. The system of claim 1 wherein the number of treatment cartridges in the at least one repeating unit in the treatment section is in the range of two and thirty, and each additional treatment cartridge first outlet is in removable communication with the at least one other treatment cartridge inlet such that any one or more treatment cartridges are operable to be in removable communication with the other treatment cartridges within the at least one repeating unit.

6. The system of claim 2 adapted for changing the number of repeating units during fluid circulation in the treatment section by removing at least one repeating unit from communication with the treatment section and disconnecting the repeating unit from the treatment section.

7. The system of claim 5 adapted for changing the number of treatment cartridges during fluid circulation in the treatment section by removing at least one treatment cartridge from communication with its repeating unit and disconnecting the treatment cartridge from its repeating unit.

8. The system of claim 2 adapted to circulate the fluid by concomitant pressure and vacuum forces on the fluid.

9. The system of claim 5 adapted to circulate the fluid by concomitant pressure and vacuum forces on the fluid.

10. The system of claim 5 wherein the wood pieces are comprised of at least one wood spiral having a char level of number 3 or number 4.

11. The system of claim 8 adapted to circulate the fluid at net positive pressure in the repeating unit.

12. The system of claim 8 adapted to circulate the fluid at net negative pressure in the repeating unit.

13. The system of claim 5 further adapted to apply any one or more of pressure, vacuum and a combination thereof to the at least one treatment cartridge substantially unfilled with fluid other than at most residual fluid wetting the interior of the at least one treatment cartridge filled with wood pieces and fluid imbued in the wood pieces.

14. A system for expedited aging of a distillate comprising:
a fluid circulation pathway comprising a pressure pump, a vacuum pump, a first vessel,
and a second vessel, each of the first and second vessels are adapted to be in removable communication with the fluid circulation pathway,
at least one of the vessels is adapted to hold wood pieces in the fluid circulation pathway and is filled with wood pieces,
the fluid circulation pathway is adapted to prevent loss of volatile fluid components,
the fluid circulation pathway is further adapted so that
(a) when circulating the fluid, the force applied onto the wood pieces is in the direction of the fluid circulation through the vessel holding the wood pieces, and
(b) the vessel holding the wood pieces is operable to hold the fluid in the vessel under pressure or vacuum when
(i) the vessel is substantially unfilled with fluid other than fluid wetting the interior of the at least one vessel and fluid imbued in the wood pieces, or
(ii) is filled with at least an amount of fluid sufficient to swell the wood pieces.

15. The system of claim 14 further adapted to monitor at least one fluid property endpoint wherein the endpoint is any one or more of (a) at least one measured property of the fluid does not change more than about two percent relative to a measurement made immediately prior, and (b) the measured property of the fluid is the same or substantially similar to the same measured fluid property of a reference aged distilled spirit.

16. The system of claim 14 adapted to circulate the fluid by concomitant pressure and vacuum forces on the fluid.

17. The system of claim 15 wherein the measured fluid property is light transmission.

18. The system of claim 15 wherein the wood pieces are comprised of French charred oak flavored with any one or more of vanilla, coffee, port, and cola flavored soda.

19. The system of claim 16 adapted to circulate the fluid at net positive pressure in the repeating unit.

20. The system of claim 16 adapted to circulate the fluid at net negative pressure in the repeating unit. PRIVILEGED & CONFIDENTIAL CLIENT
